(19) United States
(12) Patent Application Publication
(10) Pub. No.: US 2026/0260563 A1
(43) Pub. Date: Sep. 3, 2026

(54) BRAKE LIGHT DISPLAY OF OBSCURED ROAD USERS IN AUGMENTED REALITY

(71) Applicant: MERCEDES-BENZ GROUP AG, Stuttgart (DE)

(72) Inventor: Michael ENGEL, Stuttgart (DE)

(21) Appl. No.: 19/489,961

(22) PCT Filed: Mar. 4, 2024
(86) PCT No.: PCT/EP2024/055607

§ 371 Date: Dec. 4, 2025

(30) Foreign Application Priority Data
Jun. 5, 2023 (DE) 10 2023 002 285.3

(51) Int. Cl. G08G 1/01; B60K 35/23; G06T 5/80; G06T 11/00; G06V 20/20; G06V 20/54; G06V 20/58; G06V 20/62; G08G 1/017

(52) U.S. Cl. CPC G08G 1/0112; B60K 35/23; G06T 5/80; G06T 11/00; G06V 20/20; G06V 20/54; G06V 20/584; G06V 20/625; G08G 1/0141; G08G 1/017; B60K 2360/178; G06T 2207/30236; G06T 2207/30261; G06V 2201/08

(57) ABSTRACT

A rear vehicle determines a number plate of the vehicle driving in front, compares it with a central database for pre-registration, and when this is established sends a request to check whether the absolute position of the vehicle driving in front and that of the rear vehicle are within a predetermined common range. When this is the case sensor information is continuously transmitted from the vehicle driving in front to the rear vehicle via the other road users, the transmitted sensor information is analyzed for activation of brake lights of the other road user. When these are recognized as activated and the rear vehicle establishes that the brake lights of the vehicle driving in front are meanwhile not activated a symbol of activated brake lights is displayed that is fixed to the vehicle driving in front for the driver of the rear vehicle in augmented reality.

### BACKGROUND AND SUMMARY OF THE INVENTION

Exemplary embodiments of the invention relate to a method for displaying information for a driver of a rear vehicle about a braking of another road user in front of a vehicle driving directly in front of the rear vehicle.

In public traffic, situations sometimes arise where a driver of a vehicle fails to recognize other road users, or does so too late, since they are obscured by an object or another road user. This also makes anticipatory driving more difficult, since not all remaining traffic is visible. Such an obscuration problem can occur in particular when one's own vehicle, such as a passenger car, is driving behind a significantly larger vehicle such as a truck, but also, for example, when a small car is driving behind an off-road vehicle designed for cities or a small van. On the one hand, urban off-road vehicles are becoming increasingly popular among consumers; on the other hand, there is a trend toward using small and aerodynamically optimized electric vehicles that are rather narrow and/or flat. Even when maintaining a sufficiently large distance from the vehicle driving in front, here other road users driving in front can still be obscured. Such a situation requires increased attention from the driver of the following vehicle.

To solve this obscuration problem, EP 3 399 330 A1 relates to an object detection system for an automated vehicle, comprising: an object detector that detects detectable objects in the vicinity of one's own vehicle; a receiver that receives an indication of an object presence from other transmitters in the vicinity of one's own vehicle; and a controller in connection with the object detector and the receiver, wherein the controller is configured in order to operate one's own vehicle in order to avoid a collision with a concealed object when the concealed object is not recognized by the object detector and the presence of the object is displayed by at least two instances of the other transmitters.

Exemplary embodiments of the invention are directed to reducing a potential danger for a rear vehicle when another road user is or can be obscured by a vehicle driving in front of the rear vehicle.

DE 102006019495 A1 relates to a device for transmitting a warning signal depending on a status signal relating to another vehicle. The device has a signal receiver for receiving the status signal and for providing an output signal corresponding to the status signal. Furthermore, the device has a processing device for processing the output signal provided by the signal receiver and a signal transmitter for transmitting a warning signal based on the output signal processed by the processing device.

DE 102017216215 A1 relates to a method for displaying braking events of vehicles driving in front in a vehicle. In the method according to the invention, the vehicles driving in front are recorded. Data on the acceleration of the vehicles driving in front are recorded. Furthermore, from the data on the acceleration, first vehicles driving in front with a first acceleration are ascertained, wherein the first acceleration is a negative acceleration whose magnitude is greater than or equal to a set threshold value. In addition, first graphical objects are generated on a display surface, wherein a first graphical object is allocated to each first vehicle driving in front, said object displaying that the first vehicle driving in front allocated to the first graphical object exhibits the first acceleration. The invention further relates to a device for displaying accelerations of vehicles driving in front in a vehicle.

DE 102013217436 A1 relates to a driver assistance system in an ego vehicle, in particular having an electronic control unit for detecting a turning maneuver, which contains means for receiving car-to-car information signals from other vehicles. Here, defined information from a received car-to-car information signal of a vehicle driving in front is evaluated with respect to its possible turning maneuver, wherein the defined information contains at least one turn-instruction signal.

DE 102011088130 A1 describes a method for recognizing a braking situation of a vehicle on a traffic route, comprising the following steps: ascertaining a red component of at least one image region of an image that depicts at least one portion of the traffic route; and determining the braking situation based on the red component, and ascertaining a further red component of at least one image region of a further image that depicts at least one portion of the traffic route at a different time to the image, and in which, in the step of determining, the braking situation is determined based on the red component and the further red component.

DE 102006055344 A1 relates to a method for wireless communication between vehicles, in which: a second vehicle located relative to a first vehicle is identified by the first vehicle; the second vehicle wirelessly transmits driving information which is received by the first vehicle, wherein the driving information comprises information about the traffic situation in the surroundings of the second vehicle and/or about state variables of the second vehicle; the driving information received in the first vehicle is processed in the first vehicle, and the processed driving information is at least partially output via output means in the first vehicle.

A first aspect of the invention relates to a method for displaying information for a driver of a rear vehicle about a braking of another road user in front of a vehicle driving immediately in front of the rear vehicle, having the steps:
the rear vehicle ascertaining a number plate of the vehicle driving in front,
comparing the ascertained number plate of the vehicle driving in front with a central database for pre-registration, and when such pre-registration is established:
the rear vehicle sending a request to obtain an absolute position of the vehicle driving in front; and
after receiving the absolute position of the vehicle driving in front, checking whether the absolute position of the vehicle driving in front and an absolute position of the rear vehicle are within a predetermined common range, and when this is established to be the case:
continuously transmitting sensor information from the vehicle driving in front to the rear vehicle, wherein the sensor information comprises data on the surroundings in front of the vehicle driving in front, including any other road user in the surroundings and their lights; and
analyzing the transmitted sensor information for activation of the brake lights of the other road user, and when these are recognized as activated and the rear vehicle establishes that the brake lights of the vehicle driving in front are not activated: displaying a symbol of activated brake lights that is fixed to the vehicle driving in front for the driver of the rear vehicle in augmented reality.

The vehicle driving in front and the rear vehicle directly behind the vehicle driving in front form a pair of vehicles driving one behind the other, wherein the vehicle driving in front has the potential to obscure other road users in front of the vehicle driving in front from the rear vehicle. This is the case, in particular, when the vehicle driving in front is larger and/or taller than the rear vehicle. In order to mitigate this potential obscuration, a process can be initiated by the rear vehicle in order to obtain information of a sensor unit of the vehicle driving in front, which records the surroundings in front, including other road users in front of the vehicle driving in front.

To this end, a so-called “handshake” takes place in a first step in order to connect the vehicle driving in front and the rear vehicle via information technology.

Thus, the rear vehicle firstly records and evaluates a number plate of the vehicle driving in front, and then uses a central database to determine whether the vehicle driving in front is participating in a corresponding program under its number plate and has registered for it in advance.

If this is the case, the absolute positions, in particular positions ascertained based on satellites, of the vehicle driving in front and the rear vehicle are checked to determine whether they are in close proximity to each other, in order to ensure that only vehicles that are actually nearby (to the rear) are able to make such a request and receive the sensor information from the vehicle driving in front. Two-factor authentication thus takes place in order to be able to complete the “pairing” of the vehicle driving in front and the rear vehicle.

Only when the vehicle driving in front participates in a corresponding program according to the number plate and the rear vehicle driving in the immediate vicinity behind the vehicle driving in front makes a request, can sensor information be continuously transmitted from the vehicle driving in front to the rear vehicle.

Preferably, the transmission of the sensor information is carried out from the vehicle driving in front to the rear vehicle by means of a wireless transmission using the 5G standard. In principle, a transmission via Wi-Fi, Bluetooth, or other older standards is also possible, but may lead to stability issues during transmission or be inappropriate due to excessive delays. Furthermore, compressed and/or pre-processed sensor information is preferably transmitted from the vehicle driving in front to the rear vehicle.

The brake lights of the other road user must be recognized in their specific design in the sensor information. The goal is to determine the most accurate 2D model of the brake lights in relation to the vehicle silhouette. Since the vehicle silhouette constantly changes in size due to the changing distance, the 2D image of the brake lights must also be adjusted in this ratio. There are three options for this: static detection of the brake lights, the use of 3D data from the manufacturer of the other road user, or via dynamic recognition of the brake lights (e.g. brake lights flash once) after pre-registration of the other road user.

Images captured by a camera of the road user driving in front can be scanned for red objects by means of well-known image processing methods. The advantage of this is that this analysis is carried out quickly, since no initial braking process by the other road user is required here; however, this method can be inaccurate. Alternatively, images captured by a camera of the vehicle driving in front can be scanned for bright red objects. For example, sensor data after the other road user has reduced speed (e.g., after a braking intervention) can be used as a trigger, and the exact position and shape of the brake lights can then be determined using differential images. Using methods such as the classic ray theorem, this 2D model can or must be adjusted according to the distance to the vehicle (or the vehicle size). The advantage of this is that a very accurate image (2D model) of the brake lights is obtained. The disadvantage, however, is that the other road user must brake at least once in order to enable static detection for a model and to be able to then optimize it with dynamic recognition.

Alternatively, it can furthermore be provided that, following a pre-registration of the other road user, data is correspondingly transmitted. However, it may not be possible to guarantee that such data is also available; secondly, the data would have to be transferred quickly from the central database to the rear vehicle. Pre-registration for this purpose can, however, be omitted if it were to become standard and/or mandatory in the future for every vehicle participating in road traffic to make its sensor data (in particular anonymized) available to the public. This approach represents at least the most accurate method, but requires at least a one-time transmission of the data to the rear vehicle.

Accordingly, this is followed by analyzing the transmitted sensor information for activation of brake lights of the other road user, preferably in a processing unit of the rear vehicle, or alternatively in a central processing unit such as a central server of a cloud. If it is recognized that the brake lights of the other road user are activated while the brake lights of the vehicle driving in front are not activated, a symbol of activated brake lights, fixed to the vehicle driving in front, is displayed to the driver of the rear vehicle in augmented reality.

If a generated 2D grid model of the brake lights is used, it is scaled according to the distance to the vehicle driving in front. The scaling and position are adjusted in proportion to the outer contour of the vehicle driving in front. In order to project a virtual brake light exactly onto the brake lights of the vehicle driving in front, in the first step, the other road user must be permanently recorded and the outer vehicle contours determined, in order to scale the position and size of the brake lights according to the recorded data or transmitted 2D data.

Subsequently, the scaling factor of the recorded rear 2D contour of the vehicle driving in front is calculated based on the single recorded reference data, and the position and size of the projection area of the brake lights are correspondingly calculated. This calculated target data of the symbolism with the virtual brake lights is passed on, in particular, to a projection algorithm, which then creates the necessary ratio change of the image data for the projection.

In the simplest case, the symbolism has red bars, but can also have additional known symbols such as warning triangles, or is modelled on the shape and color of real brake lights, in particular exactly the shape and color of the brake lights of other road users, or when it is desired to cover the brake lights of the vehicle driving in front, its brake lights.

In the latter case, displaying the symbol of the brake lights is carried out congruently over the location of the actual brake lights of the vehicle driving in front by means of the head-up display, in particular via a head-up display. The projection of the symbol then carried out whenever the vehicle in front of the vehicle in front brakes, but the vehicle in front has not (yet) braked. This increases safety and helps prevent rear-end collisions.

A possible further use of such a method is also in the field of electronic drawbars, also called “platooning”, in which the overall efficiency of several vehicles is increased by allowing them to drive one behind the other at a very short distance, while special mechanisms are provided to ensure safety, for example in order to prevent a chain reaction of rear-end collisions in the event of emergency braking by the vehicle right at the front.

According to an advantageous embodiment, in the rear vehicle, the symbol of activated brake lights is depicted visually on a head-up display.

To correctly display the symbols on a head-up display, in particular one that indicates activated brake lights, the respectively current gaze direction of the vehicle is advantageously ascertained by eye-tracking methods. If the focus of the driver is outside the head-up display, a warning tone or other visual warning can be issued.

According to a further advantageous embodiment, a warning is issued to the rear vehicle when the focus of the driver is outside the head-up display.

According to a further advantageous embodiment, the symbol of activated brake lights is depicted in the rear vehicle in a fixed position superimposed over the brake lights of the vehicle driving in front.

For exact superimposition, a projection of the symbol onto the brake lights of the vehicle driving in front, adjusted to the distance between the vehicle driving in front and the rear vehicle and to the relative lateral position, is necessary, for example as explained above in more detail. This embodiment is used in particular when the other road user is braking, which is evident from the illumination of its brake lights and can be read from the sensor data of the vehicle driving in front, but the vehicle driving in front itself is not yet braking, since otherwise the (non-)illumination of the brake lights of the vehicle driving in front would be obscured, and in the event of an error, the correct recognition of the brake lights of the vehicle driving in front by the driver of the rear vehicle could no longer be guaranteed.

According to a further advantageous embodiment, the symbol of activated brake lights is displayed in the rear vehicle spatially distorted depending on the relative orientation angles between the rear vehicle and the vehicle driving in front.

According to this embodiment, a predetermined symbol is adapted not only depending on the distance between the vehicle driving in front and the rear vehicle, but also depending on the relative orientation angles of the two vehicles. To display the symbol, corresponding transformations are thus carried out; in addition to translation and scaling depending on the distance between the vehicles, this thus also includes a rotation of the symbol depending on the orientation angles, and a corresponding distortion/shearing. Thus, realistically simulated brake lights can be depicted superimposed over those of the vehicle driving in front, as if they were arranged on the vehicle driving in front.

Here, the real shapes of the brake lights of the other road user can also be depicted in the symbol in order to accurately reproduce the shape and characteristics of the brake lights of the other road user and to enable the generation of a virtual duplicate of the brake lights of the other road user.

According to a further advantageous embodiment, the symbol of activated brake lights is depicted in the rear vehicle in a fixed position relative to a rear side of the vehicle driving in front, but with the original geometric proportions of the brake lights of the vehicle driving in front.

Here, the outer contours of the vehicle driving in front are chosen as a reference in order to virtually depict the brake lights of the other road user, virtually adjusted to the contours of the vehicle in front.

According to a further advantageous embodiment, the symbol of activated brake lights has invariant symbols that are independent of the type of the other road user. In the simplest case, these are, for example, red rectangles.

According to a further advantageous embodiment, the symbol of activated brake lights in the rear vehicle has symbols chosen depending on the type of the other road user.

According to a further advantageous embodiment, the central database receives the request to obtain the absolute position of the vehicle driving in front and, upon pre-registration of the vehicle driving in front, checks the absolute position of the vehicle driving in front and the rear vehicle to see whether they are in the predetermined common area relative to each other and, if positive, gives the vehicle driving in front permission to transmit the sensor information to the rear vehicle.

According to a further advantageous embodiment, the continuous transmission of sensor information from the vehicle driving in front to the rear vehicle is stopped when the rear vehicle leaves the lane of the vehicle driving in front and/or another vehicle positions itself between the vehicle driving in front and the rear vehicle, or when a minimum distance between the vehicle driving in front and the rear vehicle is exceeded, wherein the minimum distance is chosen in particular depending on speed.

Further advantages, features and details emerge from the description below, in which—optionally with reference to the drawing—at least one exemplary embodiment is described in detail. The same, similar and/or functionally identical parts are provided with the same reference number.

### BRIEF DESCRIPTION OF THE DRAWING FIGURES

Here are shown in:

FIG. 1: A method for transmitting information from a vehicle driving in front to a rear vehicle according to an exemplary embodiment of the invention.

FIG. 2: A traffic situation in which the method according to FIG. 1 can be used.

FIG. 3: A traffic situation in which the method according to FIG. 1 is ended.

FIG. 4: A visualization, used in the method according to FIG. 1.

The depictions in the Figures are schematic and not true to scale.

### DETAILED DESCRIPTION

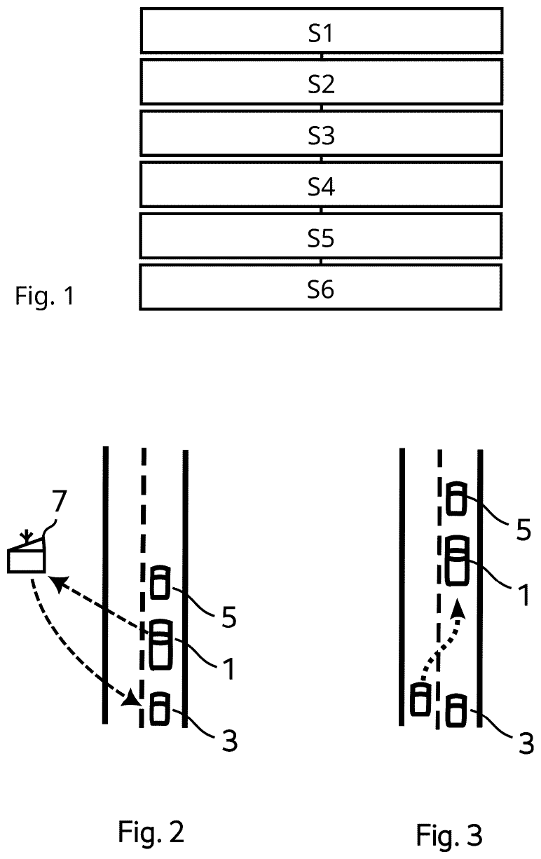

FIG. 1 shows a method for transmitting information from a vehicle 1 driving in front to a rear vehicle 3 located immediately behind the vehicle 1 driving in front about another road user 5 in front of the vehicle 1 driving in front. To understand the method, FIG. 2 can also be used, in which a corresponding traffic situation is shown, wherein in particular the vehicle 1 driving in front is a van and has corresponding dimensions that significantly exceed the rear vehicle 3 driving behind. Thus, this can result in a driver of the rear vehicle 3 failing to see another road user 5 who is located in front of the vehicle 1 driving in front, and for example, if the other road user 5 brakes sharply, the vehicle 1 driving in front will perform an emergency stop.

However, if the rear vehicle 3 is already informed that the other road user 5 is braking, although they are obscured by the vehicle 1 driving in front, the rear vehicle 3 can also initiate braking earlier, thus preventing the formation of a traffic jam due to an overreaction when braking, and preventing a rear-end collision between the rear vehicle 3 and the vehicle 1 driving in front. For this purpose, in a first step of the method, a number plate of the vehicle 1 driving in front is determined (S1) by the rear vehicle 3 in order to perform a comparison (S2) of the determined number plate of the vehicle 1 driving in front with a central database 7 for a pre-registration.

If the preceding road user 1 has correspondingly registered once in advance and their number plate is stored in the database 7 with such a feature, the rear vehicle 3 or the database 7 itself sends (S3) a request to the vehicle 1 driving in front to obtain a WGS-84 position of the vehicle 1 driving in front. A check (S4) is now performed to determine whether the WGS-84 position of the vehicle 1 driving in front and a WGS-84 position of the rear vehicle 3 are within a predefined shared moving area, i.e., whether they are in close proximity to one another. For this purpose, the shared area is assumed to move along with the vehicle 1 driving in front.

If the rear vehicle 3 is within the area around the vehicle 1 driving in front, a continuous transmission (S5) of sensor information takes place from the vehicle 1 driving in front to the rear vehicle 3, wherein the sensor information comprises data about the surroundings in front of the vehicle 1 driving in front, including any other road user 5 located in these surroundings. This sensor information comprises, in particular, camera data from the vehicle 1 driving in front, which captures the surroundings in front of the vehicle 1 driving in front and thus the other road user 5. This is followed by the analysis (S6) of the transmitted sensor information for the activation of brake lights of the other road user 5. When these are recognized as activated and it is established that the brake lights of the vehicle 1 driving in front are not activated while the brake lights of the other road user 5 are activated, a symbol of activated brake lights that is fixed in position relative to the vehicle 1 driving in front is displayed to the driver of the rear vehicle 3 in augmented reality only for this period of time.

In contrast to FIG. 2, for which the method according to FIG. 1 is fully applied, FIG. 3 shows a situation in which a gap has opened up between the rear vehicle 3 and the vehicle 1 driving in front, and another vehicle is about to merge into this gap. For the rear vehicle 3, there is now no longer any immediate need to receive the sensor information from the vehicle 1 driving in front about the other road user 5. Thus, the continuous transmission of sensor information from the vehicle driving in front to the rear vehicle is interrupted when the other vehicle merges into the gap, or when the distance between the vehicle 1 driving in front and the rear vehicle 3 has already become too great.

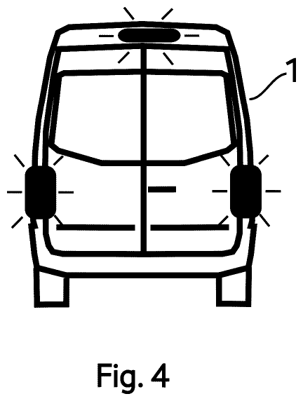

FIG. 4 shows the augmented view from the perspective of a driver of the rear vehicle 3 with the projection of a head-up display onto the vehicle 1 driving in front. The head-up display displays symbols for the driver of the rear vehicle 3 that symbolize brake lights. Corresponding to the capabilities of the head-up display, red illuminated brake lights are virtually superimposed on the vehicle 1 driving in front, as if its own brake lights were active. In reality, however, the symbol is depicted while the other road user 5, who is obscured by the vehicle 1 driving in front, is braking, but the vehicle 1 driving in front itself is not. Here, the virtual brake lights and their illumination are scaled to the peripheral geometry of the vehicle 1 driving in front, as if the brake lights of the vehicle 1 driving in front itself were active.

Although the invention has been illustrated and explained in detail by means of preferred exemplary embodiments, the invention is not limited by the disclosed examples, and other variations can be derived therefrom by the person skilled in the art without leaving the scope of the invention. It is thus clear that a multitude of possible variations exist. It is also clear that embodiments mentioned by way of example really only represent examples that are not to be understood in any way as limiting, for example, the scope, possible applications, or the configuration of the invention. Rather, the preceding description and the description of the figures enable the person skilled in the art to specifically implement the exemplary embodiments, wherein the person skilled in the art, with knowledge of the disclosed inventive concept, can make various changes, for example with regard to the function or arrangement of individual elements mentioned in an exemplary embodiment, without leaving the scope of protection which is defined by the claims and their legal equivalents, such as further explanations in the description, for example.

1-10. (canceled)

11. A method for displaying information to a driver of a rear vehicle about a braking of another road user in front of a vehicle driving immediately in front of the rear vehicle, the method comprising:
determining, by the rear vehicle, a number plate of the vehicle driving in front;
comparing the determined number plate of the vehicle driving in front with a central database for pre-registration, and responsive to the pre-registration being established
sending, by the rear vehicle, a request to obtain an absolute position of the vehicle driving in front; and
checking, after receiving the absolute position of the vehicle driving in front, whether the absolute position of the vehicle driving in front and an absolute position of the rear vehicle are within a predetermined common range, and responsive to the rear vehicle and the vehicle driving in front being within the predetermined common range
continuously transmitting sensor information from the vehicle driving in front to the rear vehicle, wherein the sensor information comprises data on surroundings in front of the vehicle driving in front, including any other road user in the surroundings and lights of the any other road user;
analyzing the transmitted sensor information for activation of brake lights of the any other road user; and
responsive to recognizing activation of the brake lights of the any other road user and the rear vehicle establishing that the brake lights of the vehicle driving in front are not activated, a symbol of activated brake lights that is fixed to the vehicle driving in front for the driver of the rear vehicle is displayed in the rear vehicle in augmented reality.

12. The method of claim 11, wherein the symbol of activated brake lights is visually depicted on a head-up display of the rear vehicle.

13. The method of claim 12, wherein a warning is output in the rear vehicle when a focus of the driver is outside the head-up display.

14. The method of claim 11, wherein the symbol of activated brake lights is depicted fixed and superimposed on the brake lights of the vehicle driving in front.

15. The method of claim 14, wherein the symbol of activated brake lights is depicted spatially distorted depending on relative orientation angles between the rear vehicle and the vehicle driving in front.

16. The method of claim 11, wherein the symbol of activated brake lights is shown fixed to a rear side of the vehicle driving in front with original geometric proportions of the brake lights of the vehicle driving in front.

17. The method of claim 11, wherein the symbol of activated brake lights has invariant symbols that are independent of a type of the any other road user.

18. The method of claim 11, wherein the symbol of activated brake lights has symbols chosen depending on a type of the any other road user.

19. The method of claim 11, the central database receives the request to obtain the absolute position of the vehicle driving in front, checks the absolute position of the vehicle driving in front and of the rear vehicle in pre-registration of the vehicle driving in front to respectively determined whether the rear vehicle and the vehicle driving in front are in the predetermined common range relative to each other, and if so the central database provides the vehicle driving in front permission to transmit the sensor information to the rear vehicle.

20. The method of claim 11, wherein the continuous transmission of sensor information from the vehicle driving in front to the rear vehicle is stopped when the rear vehicle leaves a lane of the vehicle driving in front, when another vehicle positions itself between the vehicle driving in front and the rear vehicle, or when a minimum distance between the vehicle driving in front and the rear vehicle is exceeded.
